(19) United States
(12) Patent Application Publication
(10) Pub. No.: US 2026/0008650 A1
(43) Pub. Date: Jan. 8, 2026

(54) METHOD FOR CONTROLLING AN ELEVATOR

(71) Applicant: Inventio AG, Hergiswil (CH)

(72) Inventors: Nicola Ischia, Milano (IT); Vincent Cabrini, Thalwil (CH); Thomas Cros, Toulouse (FR)

(21) Appl. No.: 18/993,614

(22) PCT Filed: Jul. 13, 2023
(86) PCT No.: PCT/EP2023/069414

§ 371 Date: Jan. 13, 2025

(30) Foreign Application Priority Data
Jul. 19, 2022 (EP) 22185605.5

(51) Int. Cl. B66B 1/06; B66B 1/34; B66B 5/00

(52) U.S. Cl. CPC B66B 1/06; B66B 1/3461; B66B 1/3492; B66B 5/0018; B66B 2201/20

(57) ABSTRACT

An elevator control method using an artificial neural network includes: receiving elevator sensor system data input at a controller configured to execute the artificial neural network trained to convert input data into at least one output value indicating a possible elevator control command, the sensor data including a current position of an elevator car with respect to building floors, a car current moving direction and a list of current calls indicating floors where the car should stop; converting the current calls into a set of arrays using the current position and the current moving direction, wherein each array stores variables indicating floors where the car should stop during a trip in one direction to the lowest or highest floor, the number of arrays being a function of the number of trips required for the car to fulfil the current calls; and generating the input data by concatenating the arrays.

### FIELD

The invention relates to methods for controlling an elevator. The invention further relates to an elevator controller, a computer program and a computer-readable medium for carrying out at least one of these methods.

### BACKGROUND

An elevator may comprise one or more cars for transporting people and/or objects between different floors of a building. Given a list of calls indicating desired floors, the elevator controller of the elevator needs to be able to determine the order of the floors at which the car(s) should stop to fulfil the calls in an efficient manner. This may also be referred to as trip scheduling.

Especially in very tall buildings with multiple floors and multiple elevators operating at the same time, solving the trip scheduling problem using conventional elevator control algorithms, which are usually based on a set of known rules, may become very complex. In such scenarios, a machine-learning model may be utilized to make better control decisions. Such models are usually trained using reinforcement learning, where actions of a simulated elevator (“agent”) are evaluated with rewards and an algorithm that controls the agent (e.g. in the form of an artificial neural network) is optimized according to the rewards so that future control decisions are better than past control decisions.

U.S. Pat. No. 5,767,461 A describes a method for controlling an elevator with cars in separate elevator shafts using an artificial neural network.

### SUMMARY

It may be seen as an objective of the invention to improve the efficiency of an elevator controller that uses an artificial neural network to process sensor data indicative of a current state of the elevator. High efficiency of an elevator controller is reflected in particular in low waiting times for passengers and/or a high transport capacity. Another objective of the invention may be to provide corresponding methods for controlling an elevator, a corresponding elevator controller, a corresponding elevator, a corresponding computer program and a corresponding computer-readable medium.

These objectives may be achieved by the subject matter of the advantageous embodiments defined in the following description and the attached drawings.

A first aspect of the invention relates to a computer-implemented method for controlling an elevator, wherein the elevator comprises a car arranged to be movable between different floors of a building. The method comprises: generating input data with a method described below; inputting the input data into an artificial neural network trained to convert the input data into at least one output value indicating a control command from a set of possible control commands for controlling the elevator; selecting one of the possible control commands as an actual control command using the at least one output value; applying the actual control command.

Examples for possible control commands are “go up”, “go down”, “go to the next floor”, “go to floor X”, or, if the elevator comprises two or more cars, “assign call 1 to car A”, “assign call 2 to car B”, etc. In other words, the output value(s) may be used to control the movement of each car and/or to assign the calls to the cars.

Applying the actual control command may cause the car to fulfil the current calls, e.g. to stop at the floors indicated by the current calls, and/or to assign the current calls to different cars of the elevator (if the elevator has more than one car).

For example, the artificial neural network may calculate one output value, e.g. one Q value, for each possible control command. In this case, the actual control command may be the possible control command corresponding to the highest output value, e.g. the highest Q value.

The named input data for the method according the first aspect of the invention is generated with a computer-implemented method for processing sensor data from a sensor system of an elevator, wherein the elevator comprises a car arranged to be movable between different floors of a building and an elevator controller for controlling the elevator and wherein the elevator controller is configured to execute an artificial neural network trained to convert input data into at least one output value indicating a possible control command for controlling the elevator. The method comprises: receiving the sensor data at the elevator controller, wherein the sensor data includes a current position of the car with respect to the floors, a current moving direction of the car and a list of current calls indicating floors at which the car should stop; converting the current calls into a set of arrays using the current position and the current moving direction, wherein each array stores variables indicating floors at which the car should stop during a trip in one direction to the lowest or highest floor of the building, wherein the number of arrays is a function of the number of trips required for the car to fulfil the current calls; generating the input data by concatenating the arrays.

A second aspect of the invention relates to a computer-implemented method for controlling an elevator, wherein the elevator comprises different cars arranged to be movable along different vertical axes between different floors of a building. The method comprises: generating input data with a method described below; inputting the input data into an artificial neural network trained to convert the input data into one output value for each car, wherein the output value indicates a probability and/or tendency for the car to be assigned to a new call indicating a desired floor of the building; determining one of the cars as a selected car using the output values; assigning the new call to the selected car.

For example, the output values may be Q values. In this case, the selected car may be the car corresponding to the highest Q value.

Regarding the method according to the third aspect of the invention, the artificial neural network may have been trained using training data generated by simulating an environment in which at least one car of an elevator moves between different floors of a building in reaction to calls indicating floors at which the car should stop.

Regarding the method according to the fourth aspect of the invention, the artificial neural network may have been trained using training data generated by simulating an environment in which different cars of an elevator move along different vertical axes between different floors of a building in reaction to calls indicating floors at which the cars should stop.

In either case, the environment may be seen as a computer-calculated space the elevator, as a virtual agent, takes actions in. The environment may have the same and/or similar characteristics as the real elevator and/or the real building in which the real elevator is installed.

As an example, the simulation of the environment may comprise the following components: elevator simulation, traffic simulation, interaction between elevator simulation and traffic simulation. The elevator simulation may be configured with at least one of the following parameters: maximum velocity, acceleration, door opening time, door closing time, minimum door open time, car capacity. The traffic simulation may be performed according to a specific traffic pattern that determines a local and/or temporal distribution of calls to be fulfilled by the elevator. For example, as mentioned above, each call may be characterized by a unique ID, a timestamp, an origin floor and a destination floor. The traffic pattern may be varied during simulation. The simulation of the interaction between the elevator and the calls (i.e. the passengers) may be configured with parameters such as a waiting time (i.e. the time a passenger waits before entering a car), a travelling time (i.e. the time a passenger travels before leaving a car) or a destination time (i.e. the overall time it takes to fulfil a call).

In general, the agent may be configured to receive an observation of the environment in each simulation step and execute an action depending on the observation, e.g. control the car(s) and/or assign a new call to one of the cars. As a reaction, the environment may update its state and emit an observation of its updated state together with a reward that is used to train the agent to improve its actions at future simulation steps.

The reward may be positive, negative or zero. For example, a positive reward value may indicate a “more useful” action, whereas a negative reward value may indicate a “less useful” action. The reward may be calculated in regular time intervals or only in certain situations, e.g. when a transition of the environment from a current state to a next state is observed.

The state of the environment may be seen as a combination of both an elevator state and a traffic state. The elevator state may be defined, for example, by at least one of the following parameters: a current floor of each car, a current moving direction of each car, a current door status (opened, moving, closed) of each car, a current number of passengers inside each car, the next reachable floors of each car. The traffic state may be defined, for example, by at least one of the following parameters: active calls from and/or to each floor, a current number of passengers inside each car, a current number of passengers waiting on each floor.

The actions may be selected with a certain degree of randomness during training, e.g. by using an epsilon-greedy algorithm. The degree of randomness may be varied, in particular reduced, as the training progresses.

It is possible that different artificial neural networks are used to assign a new call to one of the cars and to control the movement of the cars.

The methods described above and below may be carried out automatically by a processor.

The named input data for the method according the second aspect of the invention is generated with a computer-implemented method for processing sensor data from a sensor system of an elevator, wherein the elevator comprises different cars arranged to be movable along different vertical axes between different floors of a building and an elevator controller for controlling the elevator, wherein the elevator controller is configured to execute an artificial neural network trained to convert input data into one output value for each car and wherein the output value indicates a probability and/or tendency for the car to be assigned to a new call. The method comprises: receiving the sensor data at the elevator controller, wherein the sensor data includes a current position of each car with respect to the floors, a current moving direction of each car, a list of current calls assigned to the cars and the new call to be assigned to one of the cars, wherein each call indicates a desired floor of the building; performing the following converting step for each car, assuming that the new call is assigned to the car: converting the current calls assigned to the car into a first set of arrays and the new call into a second set of arrays using the current position and the current moving direction of the car, wherein each array stores variables indicating floors at which the car should stop during a trip in one direction to the lowest or highest floor of the building, wherein the number of arrays of the first set is a function of the number of trips required for the car to fulfil the current calls, wherein the number of arrays of the second set is a function of the number of trips required for the car to fulfil the new call; generating the input data by concatenating the arrays from different converting steps, in particular from all converting steps.

The artificial neural network may be, for example, a multilayer perceptron (MLP), a convolutional neural network (CNN), a recurrent neural network (RNN), a long short-term memory (LSTM), a graph neural network (GNN) or a combination of at least two of these examples. In particular, the artificial neural network may have been trained using a policy-based and/or value-based reinforcement learning algorithm.

An output value may be a value from a discrete and/or continuous value range. For example, the output value may be a Q value or bid value. The output value may also be a percentage between 0 and 1 or a Boolean value.

The calls may include one or more car operating panel (COP) calls and/or one or more landing operating panel (LOP) calls. For example, each call may be defined by a unique ID, a timestamp, an origin floor (especially only for LOP calls) and a destination floor.

The current position may be an ID of a floor on or near which the car is currently located.

The number of arrays of the same set may be a function of the minimum number of direction changes required for the car to fulfil the call(s) related to these arrays. In particular, the number of arrays of the same set may be equal to the number of trips required for the car to fulfil the call(s) related to these arrays.

For example, each array may store one variable for each floor, wherein the variable indicates whether or not the car should stop at the floor. In other words, the arrays of the same set and/or the arrays of different sets may store the same number of variables. For example, the variables may be set to 1 for “stop” and 0 for “no stop”.

The number of required trips may be determined by assuming that the car follows a known single-car control logic, such as a collective selective or down selective control logic. In this case, no more than three trips in alternating directions may be required for the car to fulfil all the calls assigned to it. Accordingly, a set of no more than three arrays, one for each trip, may be generated to encode the stops of the car.

This significantly reduces the size of the input data compared to conventional approaches and helps to process the sensor data in a more efficient way.

In particular, the input data resulting from concatenating the arrays may be or include a vector with a length proportional to the number n of floors, whereas a vector obtained by conventional approaches, such as the one described in the following, may be significantly longer, e.g. may have a length proportional to n².

A simple approach to encode the calls for one car may be to combine the following three components.

1) All landing operating panel (LOP) calls assigned to the car may be provided as origin-destination tuples and aggregated into one (two-dimensional) origin-destination matrix. The matrix may then be transformed into a first vector of length n², with n being the number of floors of the building.

2) All new LOP calls, which are to be assigned to the car, may be transformed into a second vector of length n² in the same way as described under 1). Especially only one new LOP call is taken at a given time. If there are more than one LOP calls at the same time, they were dealt sequentially one after the other.

3) All car operating panel (COP) calls from the car may be directly stored in a third vector of length n, since there is no need to remember the origin for COP calls.

The first vector, the second vector and the third vector of all cars may then be concatenated to form an observation vector to be processed by the artificial neural network.

A third aspect of the invention relates to an elevator controller comprising a processor configured to carry out at least one of the methods described above and below. The elevator controller may include hardware and/or software modules. In addition to the processor, the elevator controller may comprise a memory and one or more data communication interfaces for data communication with peripheral devices.

A fourth aspect of the invention relates to an elevator. The elevator comprises: a car arranged to be movable between different floors of a building; a sensor system adapted to provide sensor data including a current position of the car with respect to the floors, a current moving direction of the car and a list of current calls indicating floors at which the car should stop; the elevator controller described above and below, wherein the processor of the elevator controller is configured to carry out the method according to the first aspect of the invention.

Alternatively, the elevator comprises: different cars arranged to be movable along different vertical axes or in other words in different shafts between different floors of a building; a sensor system adapted to provide sensor data including a current position of each car with respect to the floors, a current moving direction of each car, a list of current calls assigned to the cars and a new call to be assigned to one of the cars, wherein each call indicates a desired floor of the building; the elevator controller described above and below, wherein the processor of the elevator controller is configured to carry out the method according to the second aspect of the invention.

Further aspects of the invention relate to a computer program comprising instructions which, when the program is executed by a processor, cause the processor to carry out at least one of the methods described above and below, as well as to a computer-readable medium in which the computer program is stored.

The computer-readable medium may be a volatile or non-volatile data storage device. For example, the computer-readable medium may be a hard drive, a USB (universal serial bus) storage device, a RAM (random-access memory), a ROM (read-only memory), an EPROM (erasable programmable read-only memory), an EEPROM (electrically erasable programmable read-only memory), a flash memory or a combination of at least two of these examples. The computer-readable medium may also be a data communication network for downloading program code, such as the Internet or a cloud.

It should be noted that features of the methods described above and below may also be features of the elevator controller, the computer program and the computer-readable medium (and vice versa).

Embodiments of the invention may be regarded as based on the ideas and findings described below without limiting the invention.

According to an embodiment, the arrays of the same set may include: a first array that stores variables indicating floors at which the car should stop during a first trip to the lowest or highest floor of the building in a first direction; a second array that stores variables indicating floors at which the car should stop during a second trip to the lowest or highest floor of the building in a second direction opposite to the first direction; a third array that stores variables indicating floors at which the car should stop during a third trip to the lowest or highest floor of the building in the first direction. The second trip may immediately follow the first trip and/or the third trip may immediately follow the second trip, that is, there may be no other trips of the car between the first trip and the second trip and/or between the second trip and the third trip. It is possible that each trip ends on the lowest or highest floor of the building. In other words, assuming a control logic according to which all calls assigned to one car can be fulfilled in no more than three trips of the car in alternating directions to the lowest or the highest floor of the building, no more than three arrays are required to encode the corresponding stops of the car. This improves the efficiency of the method.

It's also possible that the arrays of the same set may include less or more than three of the named arrays. In other words, a control logic can be assumed according to which all calls assigned to one car can be fulfilled in less or more than three trips of the car in alternating directions to the lowest or the highest floor of the building.

According to an embodiment, the first direction may be the current moving direction. For example, if the current moving direction is “up”, the first direction may be “up” too.

According to an embodiment, the first trip may start from the current position. The current position may be the lowest or highest floor or a position, e.g. a current floor, between the lowest and the highest floor. In the latter case, the first trip may be shorter than each of the second trip and the third trip.

According to an embodiment, the second trip may start on the same floor as the one on which the first trip ends. For example, the second trip may start on the lowest or highest floor. If it starts on the lowest floor, it may end on the highest floor (and vice versa).

According to an embodiment, the third trip may start on the same floor as the one on which the second trip ends. For example, the third trip may start on the lowest or highest floor. If it starts on the lowest floor, it may end on the highest floor (and vice versa).

According to an embodiment, each array may be one-dimensional. Such a one-dimensional array may also be called a vector. The shorter one-dimensional arrays may then be concatenated into a longer one-dimensional array.

According to an embodiment, the arrays may be concatenated into a one-dimensional array. This may be done by concatenating shorter one-dimensional arrays and/or by transforming multi-dimensional arrays into the one-dimensional array.

According to an embodiment, the input data is a one-dimensional array, i.e. a vector.

According to an embodiment, the input data may include additional data indicative of a current state of the elevator. For example, the additional data may include at least one of the following data: the current position (e.g. “0”, “1”, “2”), the current moving direction (e.g. “up”, “down”, “stopped”), the current occupancy (e.g. “full”, “not full”) of each car, the door status (e.g. “opening”, “opened”, “closing”), the direction after landing (e.g. “none” when the elevator is moving; If the elevator is “stopped” and the doors are moving: “up” or “down”). This may improve the accuracy of the method.

Advantageous embodiments of the invention are described in more detail below with reference to the attached drawings. Neither the description nor the drawings are to be construed as limiting the invention.

### DESCRIPTION OF THE DRAWINGS

FIG. 1 shows an elevator according to an embodiment of the invention.

FIG. 2 shows an elevator controller according to an embodiment of the invention.

FIG. 3 shows an elevator controller according to another embodiment of the invention.

FIG. 4 illustrates a single-car control logic used to process sensor data in a method according to an embodiment of the invention.

The figures are merely schematic and not to scale. Identical reference signs in the drawings denote identical features or features having the same effect.

### DETAILED DESCRIPTION

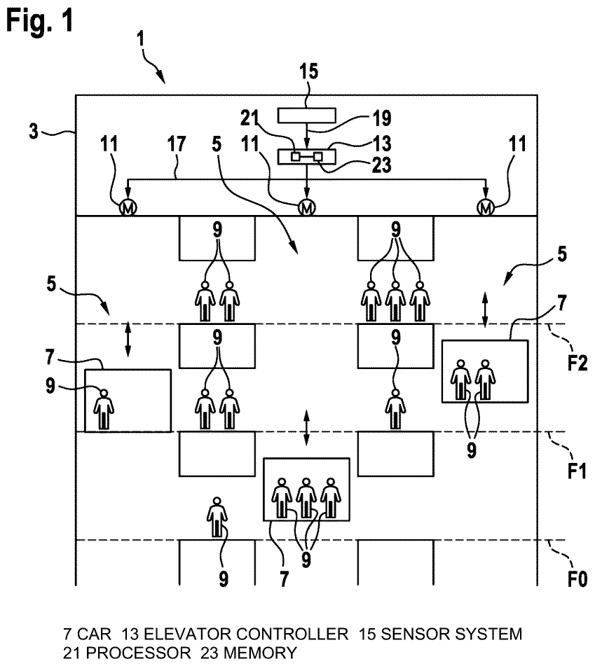

FIG. 1 shows an example of an elevator 1 installed in a building 3 with a first floor F0, a second floor F1 and a third floor F2 and three vertical shafts 5 that interconnect the three floors F0, F1, F2. The elevator 1 comprises three cars 7 for transporting passengers 9 between the floors F0, F1, F2. Each car 7 is arranged to be vertically movable along one of the three shafts 5.

The elevator 1 further comprises an actuator system 11 adapted to control a movement of each car 7. In this example, the actuator system 11 includes one electric drive (“M”) for each car 7.

In addition, the elevator 1 comprises an elevator controller 13 for controlling the elevator 1 and a sensor system 15 for detecting a current state of the elevator 1. The elevator controller is referred to in the following as controller for short. The controller 13 may be configured to generate control commands 17 for controlling the actuator system 11, i.e. the electric drives, from sensor data 19 provided by the sensor system 15.

The controller 13 comprises a processor 21 and a memory 23. The processor 21 may be configured to carry out one or both of the following methods by executing one or more computer programs stored in the memory 23.

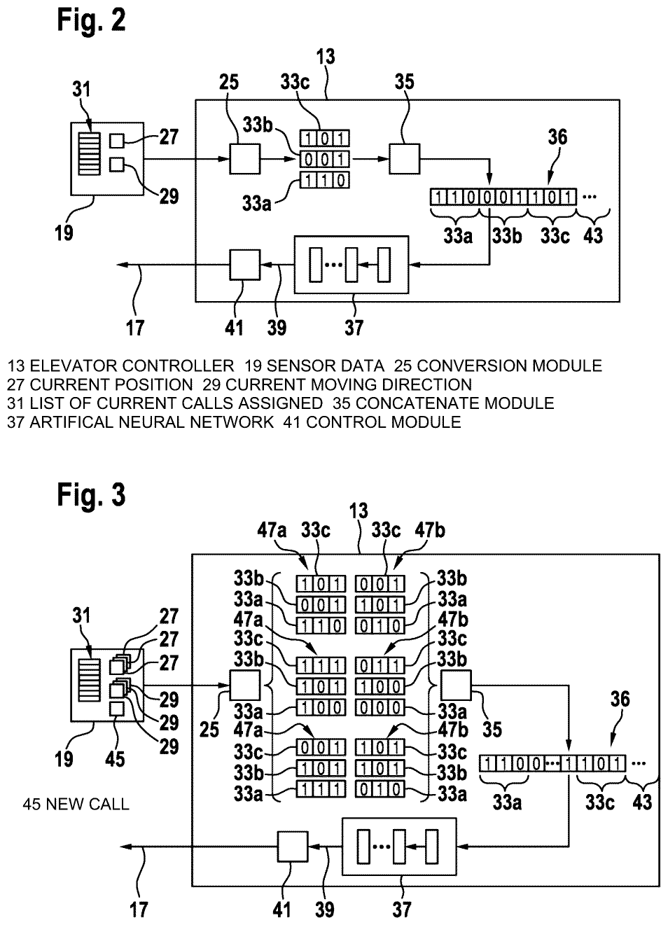

As shown in FIG. 2, the controller 13 may be configured to process the sensor data 19 separately for each car 7 with the following method.

At a first step, the sensor data 19 is received at the controller 13, here at a conversion module 25 of the controller 13. The sensor data 19 includes a current position 27 of the car 7 with respect to the floors F0, F1, F2 (such as “F0”, “F1” or “F2”), a current moving direction 29 of the car 7 (such as “up”, “down” or “stopped”) and a list 31 of current calls assigned to the car 7. Each call indicates a floor at which the car 7 should stop. For example, each call may be defined by a unique ID, a timestamp, an origin floor and a destination floor.

At a second step, the conversion module 25 converts the items from the list 31 into a set of arrays 33a, 33b, 33c using the current position 27 and the current moving direction 29. Each array 33a, 33b, 33c stores variables, such as “0” or “1”, indicating floors at which the car 7 should stop during a trip in one direction to the lowest (F0) or highest (F2) floor of the building 3. The number of arrays 33a, 33b, 33c included in the set is a function of the number of trips (or direction changes) required for the car 7 to fulfil all calls stored in the list 31. In this example, each array 33a, 33b, 33c stores one variable for each of the three floors F0, F1, F2, with “1” indicating that the car 7 should stop and “0” indicating that the car 7 should not stop. The arrays 33a, 33b, 33c may then be input into a concatenate module 35 of the controller 13.

At a third step, the concatenate module 35 concatenates the arrays 33a, 33b, 33c into input data 36 for an artificial neural network 37 executed by the controller 13.

In this example, the arrays 33a, 33b, 33c, which are one-dimensional, are concatenated into a longer (one-dimensional) vector with a length proportional to the number of floors of the building 3. This vector may then be used as the input data 36.

At a fourth step, the input data 36 may be input into the neural network 37 that has been trained to convert the input data 36 into one or more output values 39 indicating a possible control command from a set of possible control commands for controlling the elevator 1, such as “go up”, “go down”, “go to floor X” or “go to the next floor”.

At a fifth step, a control module 41 of the controller 13 may use the output value(s) 39 to select one of the possible control commands as an actual control command 17, e.g. the possible control command corresponding to the highest output value 39, and apply it. This may cause the actuator system 11 to move the car 7 in such a way that the current calls in the list 31 are fulfilled.

In this example, the conversion module 25 is configured to convert the sensor data 19 into a first array 33a, a second array 33b and a third array 33c. The first array 33a stores three variables that indicate the floors at which the car 7 should stop during a first trip to F0 or F2 in the current moving direction 29. The second array 33b stores three variables that indicate the floors at which the car 7 should stop during a second trip to F0 or F2 in a direction opposite to the current moving direction 29. The third array 33c stores three variables that indicate the floors at which the car 7 should stop during a third trip to F0 or F2 in the current moving direction 29.

For example, the first trip may start on a floor corresponding to the current position 27, e.g. F1, and end either on F0 if the current moving direction 29 is “down” or on F2 if the current moving direction 29 is “up”. The second trip may then start from the floor on which the first trip ended and end again on one of the last floors, i.e. F0 or F2. The third trip may then start from the floor on which the second trip ended and end again on one of the last floors, i.e. F0 or F2.

This makes it possible to fulfil all the calls from the list 31 in only three consecutive trips and to encode the corresponding stops in only three arrays.

Processing the sensor data 19 on the basis of such a known single-car control logic enables the neural network 37 to process the input data 36, i.e. the information relating to the current state of the elevator 1, more efficiently. This may also speed up the training procedure.

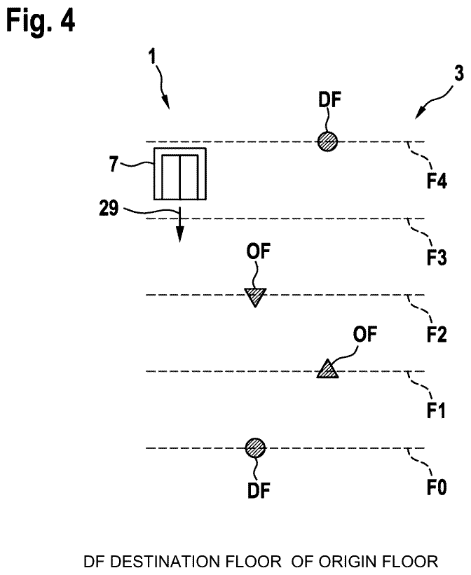

FIG. 4 illustrates how the arrays 33a, 33b, 33c may be determined in a building 3 with five floors F0, F1, F2, F3, F4. In this example, the car 7 is currently located on the highest floor F4. The current moving direction 29 of the car 7 is “down”. The car 7 has two calls assigned to it: the first one defining F2 as an origin floor OF and F0 (the lowest floor) as a destination floor DF; the second one defining F1 as an origin floor OF and F4 as a destination floor DF.

The first array 33a may then define the following stops for the first trip in the first direction, i.e. the current moving direction 29: [1, 0, 1, 0, 0]. This means that the car 7 stops at F0 and F2.

Accordingly, the second array 33b may define the following stops for the second trip in the second direction (“up”): [0, 1, 0, 0, 1]. This means that the car 7 stops at F1 and F4.

Since the two calls have already been fulfilled after the first trip and the second trip, there is no need for the third array 33c to define any further stops for the third trip in the first direction: [0, 0, 0, 0, 0].

Concatenating the arrays 33a, 33b, 33c may then give the following vector: [1, 0, 1, 0, 0, 0, 1, 0, 0, 1, 0, 0, 0, 0, 0].

Optionally, the input data 36 may include additional data 43 (FIG. 2), such as the current position 27, the current moving direction 29 or the occupancy of the car 7 (e.g. “full”, “not full”). Like the arrays 33a, 33b, 33c, the additional data 43 may be a component of the vector used as the input data 36.

FIG. 3 illustrates an alternative method that may be carried out by the processor 21 of the controller 13. The method may comprise the following steps.

At a first step, the sensor data 19 is received at the conversion module 25. In contrast to the method described above referring to FIG. 2, the sensor data 19 now includes the current positions 27 and the current moving directions 29 of all three cars 7, as well as a list 31 of current calls assigned to the cars 7 and a new call 45 to be assigned to one of the cars 7.

At a second step, the conversion module 25 performs for each car 7 the following conversion step using the current position 27 and the current moving direction 29 of the car 7. Assuming that the new call 45 is assigned to the car 7, the current calls assigned to the car 7 from the list 31 are converted into a first set 47a of arrays 33a, 33b, 33c and the new call 45 is converted into a second set 47b of arrays 33a, 33b, 33c. The first set 47a encodes the stops required for the car 7 to fulfil all current calls assigned to it, whereas the second set 47b encodes the stops required for the car 7 to fulfil the new call 45. The arrays 33a, 33b, 33c may be determined according to the same single-car control logic as described above referring to FIG. 2 and FIG. 4. The arrays 33a, 33b, 33c of the second set 47b can contain all the stops of the elevator, giving the old calls and the new one. It's also possible that the arrays 33a, 33b, 33c of the second set 47b are generated considering all the old calls and the new one, but only the stops related to the origin and destination of the new call are kept.

The arrays 33a, 33b, 33c of all sets 47a, 47b from all three conversion steps, here 18 arrays in total, may then be input into the concatenate module 35 that concatenates them, at a third step, into the input data 36.

At a fourth step, the input data 36 may be input into the neural network 37 that has been trained to convert the input data 36 into three output values 39, i.e. one for each car 7. Each output value 39 indicates a probability and/or tendency for the corresponding car 7 to be assigned to the new call 45.

At a fifth step, the control module 41 may use the output values 39 to determine the car 7 corresponding to the highest output value 39 as a selected car and assign the new call 45 to the selected car.

Optionally, the control module 41 may generate a control command 17 to cause the actuator system 11 to move the selected car in such a way that the new call 45, in addition to the other calls assigned to the selected car, is fulfilled.

The modules described above may be software and/or hardware modules.

Finally, it is noted that terms such as “comprising”, “including”, “having” or “with” do not exclude other elements or steps and that the indefinite article “a” or “an” does not exclude a plurality. It is further noted that features or steps described with reference to one of the above embodiments may also be used in combination with features or steps described with reference to any other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A computer-implemented method for controlling an elevator wherein the elevator includes a car movable between different floors of a building and an elevator controller controlling the elevator, wherein the elevator controller is configured to execute an artificial neural network trained to convert input data into at least one output value indicating a possible control command for controlling the elevator, the method comprising steps of:
receiving sensor data at the elevator controller, the sensor data being generated by a sensor system of the elevator, the sensor data including a current position of the car with respect to the floors, a current moving direction of the car and a list of current calls indicating each of the floors at which the car should stop;
generating the input data by processing the sensor data in the elevator controller to convert the current calls into a set of arrays using the current position and the current moving direction, wherein each of the arrays stores variables indicating the floors at which the car should stop during a trip in one direction to a lowest of the floors or a highest of the floors, and wherein a number of arrays in the set of arrays is a function of a number of trips required for the car to fulfil the current calls, and then concatenating the arrays into the input data;
inputting the input data into the artificial neural network to convert the input data into the at least one output value;
selecting one possible control command from a set of possible control commands as an actual control command using the at least one output value; and
applying the actual control command by the elevator controller to move the elevator car.

15. An elevator controller comprising a processor configured to perform the method according to claim 14.

16. An elevator comprising:
a car movable between floors of a building;
a sensor system generating sensor data including a current position of the car relative to the floors, a current moving direction of the car and a list of current calls indicating ones of the floors at which the car should stop; and
the elevator controller according to claim 15 controlling the movement of the car.

17. A computer program comprising instructions stored on a non-transitory computer-readable medium wherein the instructions when executed by a processor of an elevator controller cause the elevator controller to perform the method according to claim 14.

18. A non-transitory computer-readable medium comprising instructions stored thereon wherein the instructions when executed by a processor of an elevator controller cause the processor to carry out the steps of the method according to claim 14.

19. A computer-implemented method for controlling an elevator wherein the elevator includes cars movable along different vertical axes between different floors of a building and an elevator controller controlling the elevator, wherein the elevator controller is configured to execute an artificial neural network trained to convert input data into an output value for each of the cars, wherein the output value for each of the cars indicates a probability and/or tendency for the associated car to be assigned to a new call, the method comprising steps of:
generating sensor data from a sensor system of the elevator;
receiving the sensor data at the elevator controller, wherein the sensor data includes a current position of each of the cars with respect to the floors, a current moving direction of each of the cars, a list of current calls assigned to each of the cars and the new call to be assigned to one of the cars, and wherein each of the assigned current calls and the new call indicates a destination floor corresponding to one of the floors;
assuming that the new call is assigned to the car for each of the cars, converting the current calls assigned to the car into a first set of arrays and the new call into a second set of arrays using the current position and the current moving direction of the car, wherein each of the arrays stores variables indicating the floors at which the car should stop during a trip in one direction to a lowest of the floors or a highest of the floors, wherein a number of arrays of the first set is a function of a number of trips required for the car to fulfil the assigned current calls, and wherein a number of arrays of the second set is a function of a number of trips required for the car to fulfil the new call;
generating the input data by concatenating all of the arrays;
inputting the input data into the artificial neural network to convert the input data into one output value for each of the cars, wherein each of the output values indicates a probability and/or tendency for an associated one of the cars to be assigned to the new call;
determining one of the cars as a selected car using the output values; and
assigning the new call to the selected car.

20. The method according to claim 19 wherein the arrays of each of the first set and the second set include: a first array that stores the variables indicating the floors at which the car should stop during a first trip in a first direction; a second array that stores the variables indicating the floors at which the car should stop during a second trip in a second direction opposite to the first direction; and a third array that stores the variables indicating the floors at which the car should stop during a third trip in the first direction.

21. The method according to claim 20 wherein the first direction is the current moving direction of the associated car.

22. The method according to claim 20 wherein the first trip starts from the current position of the associated car.

23. The method according to claim 20 wherein the second trip starts on a one of the floors at which the first trip ends and/or wherein the third trip starts on a one of the floors at which the second trip ends.

24. The method according to claim 19 wherein each of the arrays is one-dimensional and/or wherein the arrays are concatenated into a one-dimensional array.

25. The method according to claim 19 wherein the input data is in a one-dimensional array.

26. The method according to claim 19 wherein the input data includes additional data indicative of a current state of the elevator.

27. An elevator controller comprising a processor configured to perform the method according to claim 19.

28. An elevator comprising:
cars movable between floors of a building;
a sensor system generating sensor data including a current position of each of the cars relative to the floors, a current moving direction of each of the cars and a list of current calls indicating ones of the floors at which each of the cars should stop and a new call to be assigned to one of the cars, wherein the assigned calls and the new call each indicate a destination floor corresponding to one of the floors; and
the elevator controller according to claim 27 controlling the movement of the cars.

29. A computer program comprising instructions stored on a non-transitory computer-readable medium wherein the instructions when executed by a processor of an elevator controller cause the elevator controller to perform the method according to claim 19.

30. A non-transitory computer-readable medium comprising instructions stored thereon wherein the instructions when executed by a processor of an elevator controller cause the processor to carry out the steps of the method according to claim 19.
